(19) United States
(12) Patent Application Publication
(10) Pub. No.: US 2018/0364943 A1
(43) Pub. Date: Dec. 20, 2018

(54) MEMORY MANAGEMENT ARCHITECTURE AND SYSTEM THEREFOR

(71) Applicant: Jakob Østergaard, Kgs. Lyngby (DK)

(72) Inventor: Jakob Østergaard, Kgs. Lyngby (DK)

(21) Appl. No.: 15/628,529

(22) Filed: Jun. 20, 2017

(51) Int. Cl. G06F 3/06

(52) U.S. Cl. CPC G06F 3/0659; G06F 3/064; G06F 3/0644; G06F 3/0604

(57) ABSTRACT

A method for writing data to memory includes the steps of receiving a stream of data objects. Next, the grouped data objects are grouped according to a sorting rule, wherein the sorting rule provides for grouping the data objects based on at least one of a predetermined size threshold and predetermined time threshold. Then, the grouped data objects are separated into corresponding data blocks based on the sorting rule. Finally, the grouped data blocks are written into corresponding, non-fragmented memory locations, wherein the memory locations include data blocks of substantially equal size.

### BACKGROUND OF THE INVENTION

### Field of the Invention

The present invention generally relates to memory management and data storage systems and, more particularly, to a memory management and data storage system having a novel architecture for providing efficient transmission and receipt of data.

Data backup is a common practice given the significant amounts of data, for example, pictures, movies, documents, spreadsheet, etc. that users generate and need to store on any given day. Client devices, for example, smart phones and other suitable devices often do not have enough memory to store all of the data that users create. A drawback associated conventional backup storage systems is that heavy write loads tend to become difficult to mange concurrently with heavy read loads to storage, particularly when the available memory is reaching capacity. In such situations, write performance deteriorates when the available memory capacity is beyond 80-90 percent of capacity. The underlying reason for such deterioration is that to before executing a write operation, free space must be located to hold the data that is to be written. As free space gets fragmented, for example, due to updates and deletions of existing data, it becomes more difficult to locate a large enough area of available memory to hold the new data to be written. Alternatively, the data to be written may need to be split or otherwise separated into smaller pieces to be written individually. This will result in a system performance penalty.

For various reasons, for example, hardware refresh cycles or emergencies, it may be desirable to evacuate (e.g. copy all data from one system onto another system as quickly as possible) a storage system. Traditional memories (e.g. file systems) do not perform this function well as the copy software will access the data on the file system via the named files and folders. The actual data file will be distributed across the underlying mechanical disks, that comprise the backup medium, and typically every file accessed will not immediately follow the file previously read. This incurs a seek penalty for every single file that is read. A typical seek latency on a mechanical disk is on the order of 10 ms. Therefore, to read 10 million files or objects will result in a latency of approximately twenty-eight hours. Delays of this magnitude are unacceptable to users, especially in situations where information needs to be accessed quickly.

### SUMMARY OF THE INVENTION

The present invention is directed to a method for writing data to memory including the steps of receiving a stream of data objects. Next, data object grouping is performed according to a sorting rule, wherein the sorting rule groups the data objects based on at least one of a predetermined size threshold and predetermined time threshold. Then, the grouped data objects are separated into corresponding data blocks based on a provision of the sorting rule. Finally, the grouped data blocks are written into corresponding, non-fragmented memory locations, whereby the memory locations include data blocks of substantially equal size.

The present invention also directed to a non-transitory computer readable medium that includes instructions that when executed by a processor cause the processor to receive a stream of data objects. The data objects are grouped according to a sorting rule, where the sorting rule groups the data objects based on at least one of a predetermined size threshold value and predetermined time threshold value. Next, the grouped data objects are separated into corresponding data blocks based on the sorting rule. Finally, the grouped data blocks are written into corresponding, non-fragmented memory locations, whereby the memory locations include data blocks of substantially equal size.

A feature provided by the present invention is that disk fragmentation is eliminated. The data objects written to memory are stored in their entirety in sequential, non-fragmented portions of the corresponding memory.

Another feature provided by the present invention is that a read operation is never necessary before a write operation, as additional data is written to the corresponding portions of memory to ensure that the written data objects completely populate their corresponding memory locations.

Yet another feature provided by the present invention is that free disk space management is performed simply by maintaining an integer write offset. Fragmentation never occurs as data objects are never deleted or modified. Searching for free space does not occur as one simply checks that the write offset plus the size of the group to write is no larger than the size of the disk.

A benefit provided by the present invention is that no write performance degradation occurs as the system fills the corresponding data disk to full capacity without performance degradation.

Another benefit provided by the present invention is that since data objects are stored sequentially, memory evacuation is very efficient since data objects can be read sequentially from all data disks concurrently.

### BRIEF DESCRIPTION OF THE DRAWING:

For a further understanding of the objects and advantages of the present invention, reference should be had to the following detailed description, taken in conjunction with the accompanying drawing, in which like parts are given like reference numerals and wherein:

FIG. 1 is a schematic block diagram of an electronic data system including the memory management system and architecture according to an exemplary embodiment of the present invention;

FIG. 2 is a schematic block diagram of a client device communicably coupled to a server configured with the memory management system and architecture according to an exemplary embodiment of the present invention;

FIG. 3 is a schematic block diagram of a server device of the electronic data system including the memory management system and architecture according to an exemplary embodiment of the present invention; and

FIGS. 4A-4B are flow charts illustrating the steps performed to implement the memory management system and storing data within the memory architecture

### DETAILED DESCRIPTION OF THE INVENTION

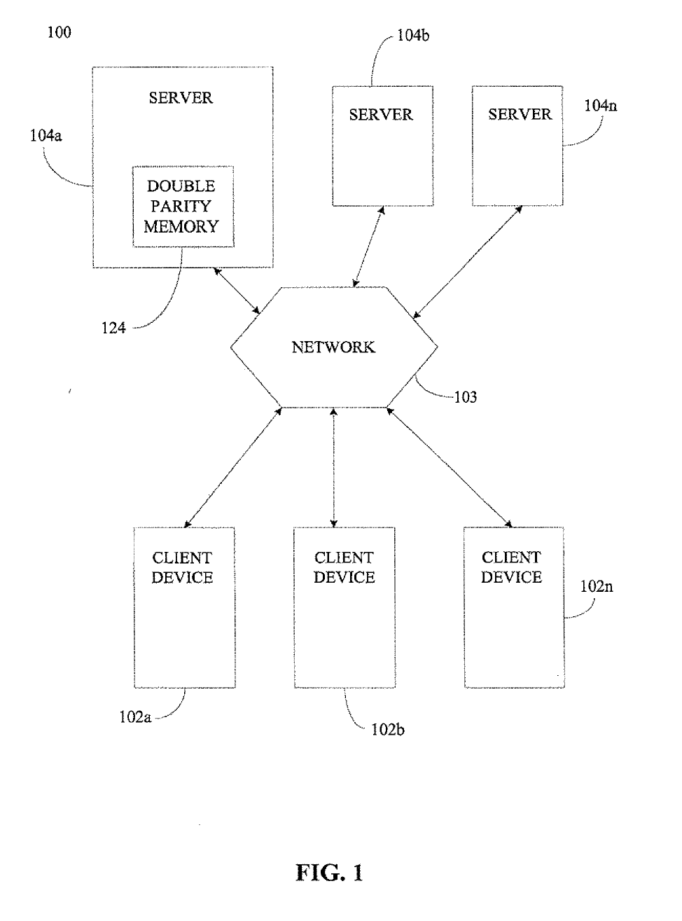

An exemplary embodiment of the present invention will now be described with reference to FIGS. 1-4B. FIG. 1 is a schematic block diagram of an electronic data system 100 implementing the memory management system architecture according to the present invention. The system 100 includes a plurality of client devices 102a-102n, for example, laptop computers, desktop computers, tablet computers, set top boxes, mobile devices, for example, smart phones or any other suitable device capable of transmitting and receiving information to and from the other client devices 102a-102n coupled to the system and/or to and from one or more of the plurality of servers 104a-104n of the system 100 through a network connection 103.

The network connection 103 may be implemented, for example, by a local area network (LAN), a wide area network (WAN), the Internet, an Ethernet connection, a wireless connection, for example, 802.11a-n, an ad hoc network, a peer-to-peer network, a mobile network or any suitable network capable to allow for the transmission of data between the client devices 102a-102n and server devices 104a-104n communicably coupled to the network 103.

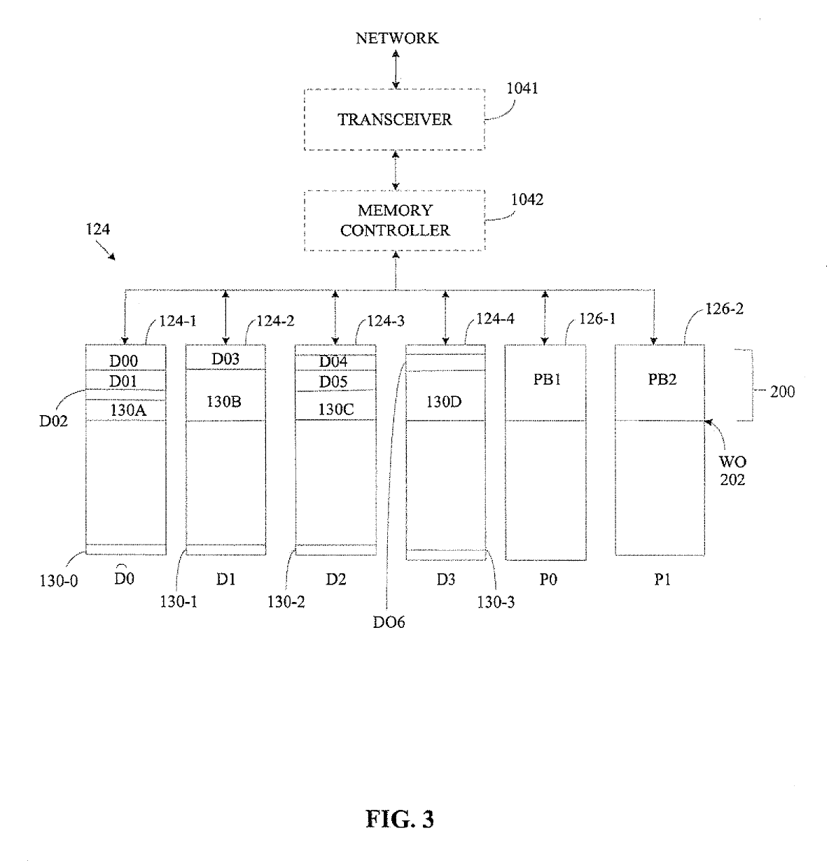

Each of the plurality of server devices 104a-104n includes a corresponding plurality of data disks configured in a double parity bit architecture 124 for storing data objects written to corresponding locations in the data disks 124-1-124-4 (FIG. 3) according to a sorting rule which provides for each of the written memory locations having the same size. The present invention takes advantage of a unique data tree architecture and naming convention, a Directed Acyclic Graph (DAG), which calls for data objects being stored and named after the hash of its contents. Under this protocol, a data object is never modified; instead, when a data object is changed or otherwise modified (including deleted or moved) in some way, such data object is written under a new name corresponding to the hash of its modified contents. This is referred to as storing snapshot trees of the data objects. In this manner, read and write operations are more efficient as reading potentially heavily fragmented memory files is precluded as the memory locations read from or written to are substantially the same size, and data objects are read sequentially from all data disks 124-1-124-4 (FIG. 3) concurrently. Moreover, data integrity is substantially increased as all files having a common hash have not been modified; therefore, the data read for memory will be more accurate as compared to the results of conventional searching protocols which may read different versions of the same and/or different files, which may lead to incorrect results. The DAG protocol and the snapshot data tree architecture are disclosed in greater detail in commonly owned, co-pending application Ser. No.______, entitled “Secure Memory and Hierarchical Structure and System Therefor”, which is incorporated in its entirety herein.

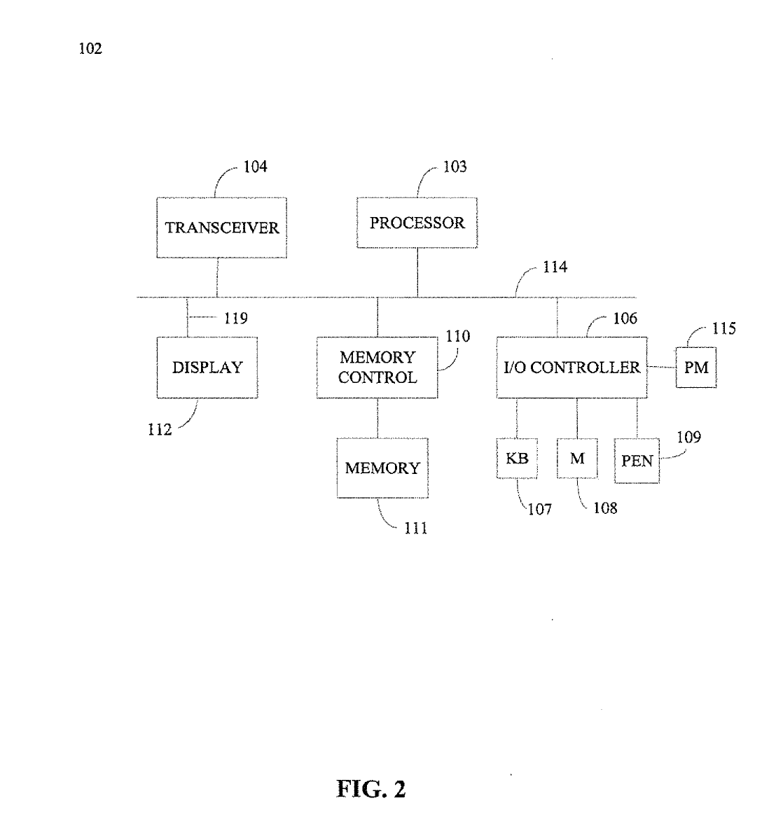

FIG. 2 is a schematic block diagram of a client device 102 communicably coupled to one or more servers configured with the memory management system and architecture according to the present invention. The client device 102 includes a processor 103, a transceiver 104, an Input/Output (I/O) Controller 106, a memory controller 110 configured to control the reading and writing of data objects to a corresponding memory 111, and a display 112. The aforementioned components are coupled to the processor 103 and electronically coupled to the other components of the client device 103 via system bus 114.

The processor 103 may be implemented, for example, by a microprocessor, a microcontroller, an application specific integrated circuit (ASIC), a field programmable gate array (FPGA) or other suitable device configured for controlling the functionality and operations of the client device 102, and to perform the operating steps necessary for reading and writing data to memory, for example, the corresponding memory 111 or one or more of the plurality of server devices 104a-104n (FIG. 1) communicably coupled to the client device 102.

The transceiver 104 may be implemented by a modem, an Ethernet connection, a local area network (LAN) connection, a wide area network (WAN) connection, an 802.11a-n connection, a mobile network connection or any suitable device or connection capable of transmitting and/or receiving data to/from the other client devices 102b-102n and the plurality of server devices 104a-104n coupled to the network 103.

The I/O Controller 106 may be implemented by any suitable device configured to receive information or data, for example, from a keyboard 107, mouse 108 or pointer device 109, for example a stylus or other input device. The I/O Controller 106 may also be configured to receive one or more portable memory or information transmission and retrieval devices 115, for example, an SD card, a flash drive, a memory stick, a jump drive, a CD-ROM drive, a DVD drive or other suitable portable memory device.

The memory controller 110 may be implemented by any suitable device capable of controlling the transmission and receipt of data objects to local memory 111. For example, the memory controller 110 may include a processor (not shown) for controlling the reading and writing of data to memory 111 based, at least in part, on instructions stored in memory (not shown) local to the memory controller 110. The memory from which such instructions are read may be either integrated within the memory controller 110 or may be stored in the local memory 111, itself.

The local memory 111 may be implemented as a random access memory (RAM), read only memory (ROM), electrically programmable read only memory (EPROM), electrically erasable and programmable read only memory (EEPROM) or any suitable memory capable of storing data and instructions that when are executed by a processor, cause the processor to control the operations and other functionality of the client device 102. In a principal embodiment, processor 103 would execute the instruction stored in local memory 111. In an alternate embodiment, a processor integrated within the memory controller 110 would execute the instructions stored in the local memory 111. Although illustrated as being connected to a local device, the memory controller 110 and the memory 111 may be configured in similar fashion to the server device discussed in greater detail with respect FIG. 3.

The display 112 may be, for example, a touch screen, a CRT display, and LED display or any suitable device capable of presenting information to a user of the client device 102. The display 112 may be integrated within the client device 102, or may be externally coupled to the client device 102 through a suitable connection 119, for example, a serial connection, a parallel connection, a wireless connection, a Bluetooth connection, an HDMI connection or other suitable connection.

FIG. 3 is a schematic block diagram of a server device 104a of the electronic data system 100 including the memory architecture 124 according to the present invention. As illustrated, the server device 104a includes a plurality of data disks 124-1-124-4 and a pair of parity disks 126-1-126-2. In a preferred embodiment, four data disks are used to store data objects and other information relating to memory management, including filler or padding information 130A-130D, received at the server device 104a. In alternate embodiments of the present invention, any suitable number of data disks 124 may be implemented. Each of the data disks 124-1-124-4 has a storage capacity of about 10 Gigabytes, although any size capacity data disk may be used.

In a preferred embodiment, the data objects (DO0-D06) and other suitable information stored in the data disks 124 may be transmitted to the server 104a from one or more of the client devices 102a-102n directly through the corresponding transceiver 104 (FIG. 2) of the respective client devices 102a-102n. Alternatively, the data objects and other suitable information may be received at the transceiver 1041 of the corresponding server device 104a, and transmitted to the corresponding data disks 124-1-124-4 under control of the memory controller 1042. The memory controller 1042 may include a processor (not shown) for controlling the reading and writing of data objects (DO0-DO6) to the data disks 124-1-124-4 based on instructions maintained in a local memory (not shown) within the memory controller 1042). In either implementation, the sorting, grouping and writing of the data objects (DO0-DO6) is performed in the same manner.

The data objects DO0-DO6 and filler or padding data 130A-130D are written to the corresponding data disks 124-1-124-4 such that upon completion of a write operation, each of the data disks 124-1-124-4 include substantially the same amount of data 200, for example, 2 Gigabytes. A stream of data objects (DO0-DO6) is received for writing. The data objects DO0-DO6 are selected and separated into groups based on a predetermined time and predetermined size threshold, for example, 100 ms worth of received data, but no more than 1 Gigabyte in total size. The bounded, or grouped, data objects are divided into four blocks of substantially equal size, based on the aforementioned threshold requirements. Filler or padding data 130A-130B may be added to the blocks of data object to ensure that the data blocks are of equal size. For example, data objects DO0-DO2 meet the minimum size threshold value but not the minimum time threshold value. In this manner, the data objects DO0-DO2 are written to data disk 124-1 with a small amount of filler of padding data 130A. Data object DO3 meets the minimum time threshold value, but does not meet the minimum size threshold value. In this instance, filler or padding data 130B is written to the data block 124-2 with the corresponding write offset 202, such that the memory allocated for the first group of data objects is substantially the same size. The same writing process is performed for data objects DO4-DO6 and data blocks 124-3 and 124-4.

Each of the equal sized data blocks are written to each of the four data disks 124-1-124-4 with a suitable write offset 202 to ensure that sequential data blocks are written sequentially to previously stored data blocks to provide for non-fragmented memory storage. The write offset 202 is calculated after each write operation and stored in a corresponding super-block 130-0-130-3 in each data disk 124-1-124-4. Parity data PB1, PB2 is calculated and written to the parity disks 126-1, 126-2 with the same write offset 202. At the end of the write operation, each of the data disks 124-1 124-4 includes blocks of data that may be sequentially read or removed from memory 124. As each of the data objects cannot be modified, read and write data integrity is maintained as subsequent read or delete operations are acted upon an entire memory data segment bound by a corresponding write offset 202. In this manner, fragmented memory searching is not undertaken or required.

When a data object is read, the data object is guaranteed to be stored in-full, sequentially without being fragmented on a single data disk (e.g. data disk 124-1). In this manner, a single logical object read becomes a single physical disk read, as bounded by the corresponding write offset 202. Thus, read-amplification, or reading more memory than required to obtain a particular piece of information is not performed.

Free space management is accomplished by maintaining an integer write offset 202 in the corresponding super-blocks 130-0-130-3 of the data disks 124-1-124-4. Searching for free space does not occur as one simply checks that the write offset 202 plus the size of the data blocks to write is no larger than the size of the disk. Fragmentation never occurs as data objects DO0-DO6 are never deleted or modified.

Data objects DO0-DO6 are stored sequentially on the data disks 124-1-124-4. Thus, there is no memory write performance degradation as very close to 100 percent of the available disk capacity is used. Additionally, as data objects DO0-DO6 are stored sequentially on the data disks 124-1-124-4, memory evacuation (e.g. deleting data objects from the data disks) is very efficient as the data objects DO0-DO6 are read sequentially from all of the data disks 124-1-124-4 concurrently. In addition, a heavy random read workload will distribute the read workload evenly across the data disks 124-1-124-4 by, for example, using other data disk/parity disk selection schemes in which disk switch roles can distribute the read workload across all participating data disks.

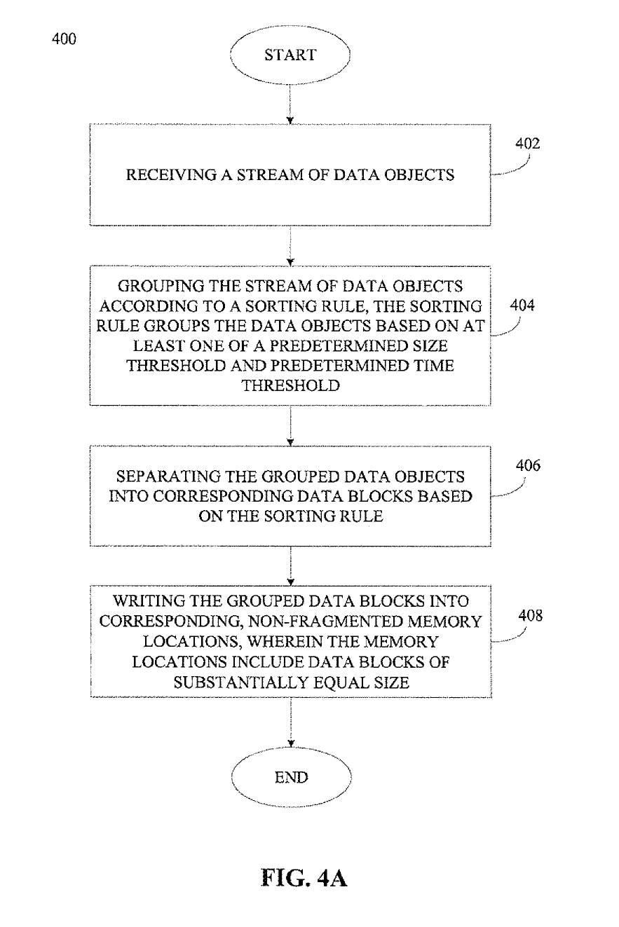

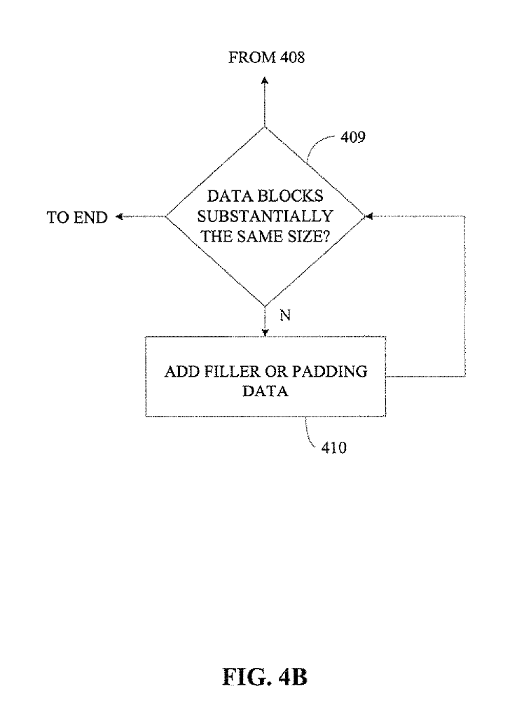

FIGS. 4A-4B are flow charts illustrating the steps performed to implement the memory management system and storing data within the memory architecture according to an exemplary embodiment of the present invention. The steps described below may be executed or otherwise performed by the processor 103 (FIG. 2) of a corresponding client device 102a (FIG. 2) writing data to either local memory 111 or one of the plurality of servers 104a-104n (FIG. 2) coupled to the network 103 (FIG. 2). Alternatively, the steps described below may be executed or other performed by the memory controller 1042 (FIG. 3) of one of the plurality of servers 104a-104n (FIG. 2) used to store long term, backup data.

The process begins at step 402, where a stream of data objects, for example, photos, movies, music files, word files, graphics files or any other suitable data file is received for storage. This may be accomplished, for example, by the processor or memory controller receiving the data objects from the transceiver.

In step 404, the received data objects are grouped according to a sorting rule, where the sorting rule groups the data objects based on at least one of a predetermined size threshold and predetermined time threshold. This may be accomplished for example, by the processor or memory controller separating the data objects into groups based on a predetermined time and predetermined size threshold values, for example, 100 ms worth of received data, but no more than 1 Gigabyte in total size. In essence, each data group is separated into groups no greater than 100 ms in length with a total size no greater than 1 Gigabyte.

In step 406, the grouped data objects are separated into corresponding data blocks based on the sorting rule. This may be accomplished by the processor or memory controller segmenting the grouped data blocks into four blocks of substantially equal size to be written into a corresponding data disk. A write offset is also calculated to determine the sizes of the corresponding data blocks to be written into memory. If one or more of the data blocks does not equal the total size as determined by the size of the particular data block and the write offset, filler or padding data is written, for example, at the end of the data block to ensure that the data blocks are substantially the same size.

In step 408, the grouped data blocks, including any necessary filler or padding date, are written into corresponding non-fragmented, sequential memory locations within the plurality of data disks, wherein the memory locations include data blocks of substantially equal size. This may be accomplished, for example, by the processor or the memory controller writing the segmented data blocks into corresponding portions of the data disks, as bounded by the write offset.

Briefly referring to FIG. 4B, in step 409 a determination is made as to whether the data blocks are substantially the same size. This may be accomplished, for example, by the processor or memory controller calculating the size of each of the data blocks, based at least in part on the size of the grouped data objects plus the write offset value. If the data blocks are substantially the same size, the process ends. If the data blocks are not substantially the same size, the process proceeds to step 410.

In step 410, additional filler or padding data is written to the corresponding data blocks to ensure they are of equal size. This may be accomplished, for example, by the processor or memory controller writing filler or padding data into the corresponding data blocks to make them the same size. The process then returns to step 409.

In a principal embodiment of the invention, the data blocks are of equal size to ensure that any subsequent write operations occur at the write offset in memory. Any subsequent data writes will follow the calculated write offset, to guarantee that data objects are always written in sequential order. Therefore, read operations do not have to be performed before write operations. This results in the memory system having minimal or zero, write latency or subsequent read delays. The process then ends.

Although the above detailed description of the invention contains many details, these should not be construed as limiting the scope of the invention but as merely providing illustrations of some of the presently exemplary embodiments of this invention. Therefore, it will be appreciated that the scope of the present invention fully encompasses other embodiments which may become apparent to those of ordinary skill in the art, and that the scope of the present invention is accordingly to be limited by nothing other than the claims appended hereto.

What is claimed is:

1. A memory, comprising:
a plurality of data disks configured to store a substantially equal amount of data objects based on a sorting rule, the sorting rule grouping the data objects based on at least one of a predetermined size threshold and predetermined time threshold, the data disks further configured to store additional data causing each portion the data disks to store a substantially equal amount of data; and
a plurality of parity disks, coupled to the, plurality of data disks, to indicate whether the grouped data objects are substantially the same size.

2. The memory of claim 1, wherein the at least one of the plurality of data disks further includes a super-block configured to maintain write offset data, wherein the write offset data provides for subsequently written data blocks being written contiguous to previously written data blocks.

3. The memory of claim 1, wherein the plurality of data disks comprises four data disks, each data disk configured to store a substantially equal amount of data objects, wherein after each write operation the four data disks have substantially equal amounts of data written therein.

4. The memory of claim 1, wherein the predetermined time threshold is about 100 ms.

5. The memory of claim 1, wherein the predetermined size threshold is about 1 Gigabytes.

6. A method for writing data to memory, comprising the steps of:
receiving a stream of data objects;
grouping the stream of data objects according to a sorting rule, wherein the sorting rule groups the data objects based on at least one of a predetermined size threshold and predetermined time threshold;
separating the grouped data objects into corresponding data blocks based on the sorting rule; and
writing the grouped data blocks into corresponding, non-fragmented memory locations, wherein the memory locations include data blocks of substantially equal size.

7. The method of claim 6, further including the steps of: (a) determining whether the memory locations are substantially the same size; and (b) writing additional data to the memory locations when the memory locations are not substantially the same size, wherein after writing the additional data into the memory locations, each of the memory locations are substantially equal sized.

8. The method of claim 6, wherein the grouped data blocks are written to a corresponding one of a plurality of data disks with a corresponding write offset.

9. The method of claim 8, wherein a second group of data blocks are written to a corresponding one of the plurality of data disks with a corresponding updated write offset, wherein the second group of data blocks are written contiguous to the previously written group of data blocks.

10. A non-transitory computer readable medium, comprising:
a processor; and
a memory, coupled to the processor, the memory including instructions that when executed by the processor cause the processor to:
receive a stream of data objects;
group the stream of data objects according to a sorting rule, wherein the sorting rule groups the data objects based on at least one of a predetermined size threshold and predetermined time threshold;
separate the grouped data objects into corresponding data blocks based on the sorting rule; and
write the grouped data blocks into corresponding, non-fragmented memory locations, wherein the memory locations include data blocks of substantially equal size.

11. The non-transitory computer readable medium of claim 10, further including instructions that when executed by the processor, cause the processor to: (a) determine whether the memory locations are substantially the same size; and (b) write additional data to the memory locations when the memory locations are not substantially the same size, wherein after writing the additional data into the memory locations, each of the memory locations are substantially equal sized.

12. The non-transitory computer readable medium of claim 10, further including instructions that when executed by the processor, cause the processor to write a corresponding one of a plurality of data disks with a corresponding write offset.

13. The non-transitory computer readable medium of claim 12, further including instructions that when executed by the processor, cause the processor to write a second group of data blocks to a corresponding one of the plurality of data disks with a corresponding updated write offset, wherein the second group of data blocks are written sequentially to the previously written group of data blocks.
